(19) United States
(12) Patent Application Publication
(10) Pub. No.: US 2019/0101128 A1
(43) Pub. Date: Apr. 4, 2019

(54) Wing or blade design for wingtip device, rotor, propeller, turbine, and compressor blades with energy regeneration

(71) Applicant: PAPA ABDOULAYE MBODJ, DAKAR (SN)

(72) Inventor: PAPA ABDOULAYE MBODJ, DAKAR (SN)

(21) Appl. No.: 15/721,957

(22) Filed: Oct. 1, 2017

(51) Int. Cl. F04D 27/00; B64C 3/00; B64C 23/06; B64C 11/18; B63H 1/26; B64C 27/46; F04D 29/38; F04D 29/30; F04D 29/54; F04D 29/44; F03D 1/06; F03D 7/02

(52) U.S. Cl. CPC F04D 27/002; B64C 3/00; B64C 23/069; B64C 11/18; B63H 1/26; B64C 27/463; F05B 2260/507; F04D 29/30; F04D 29/542; F04D 29/444; F03D 1/0675; F03D 7/0236; F04D 29/388

(57) ABSTRACT

The new wing or blade design for wingtip device, rotor, propeller, turbine, and compressor blades with energy regeneration can be used to generate lift, propel vehicles more efficiently, compress fluids more efficiently, harness energy more efficiently. This system can be used as a wing, as a wingtip device, as a propeller for aircraft or boats or any vehicle moving through a fluid, in a compressor, as a rotor for wind turbine or helicopter, in a gas turbine. The new wing or blade design for wingtip device, rotor, propeller, turbine, and compressor blades with energy regeneration is a series of low aspect ratio wings placed in parallel with gaps between them connected by smaller wings that are placed in the gaps to harness the energy and produce forces; the gaps are shaped to decelerate the fluid and/or accelerate the fluid by varying the cross-sectional area of the gaps. Even if the small aspect ratio makes those wings inefficient, the strength of the vortices is smaller in the gaps.

### BACKGROUND OF THE INVENTION

It is known that up to now lift generation surfaces as wings exist that although fulfilling the same function as the new wing or blade design for wingtip device, rotor, propeller, turbine, and compressor blades with energy regeneration, which is the subject of the invention, exhibit a certain number of technical problems which are among others: the strong wingtip vortices that are the source of induced drag and represent an issue for aviation safety; the lower efficiency of existing propeller or compressor or rotor.

The aspect ratio of a wing is defined as the span length divided by the wing area to the square. A golden rule in aerodynamics is to have the highest aspect ratio for maximum efficiency. By increasing the span and keeping the same area, the wingtip vortices are reduced. Wingtip vortices are a primary source of drag, particularly at low speed and high wing loading.

This invention called New wing, or blade design for wingtip device, rotor, propeller, turbine, and compressor blades with energy regeneration goes against that golden rule previously described. By using a series of low aspect ratio wings placed in parallel with gaps between them, the motion of the fluid around the tips due to the pressure gradient is used to increase the overall efficiency of the entire system. Smaller wings are placed in the gaps to harness the energy and produce forces. The gaps are shaped to decelerate the fluid and/or accelerate the fluid by varying the cross-sectional area. Like diverging or converging nozzles, those gaps help to vary the pressure or transform the residual energy into kinetic energy. The gaps are placed in a way that they mainly go from the point of highest pressure at the bottom of the airfoil (intrados) to the point of lowest pressure at the top of the airfoil (extrados).

Also, there are small holes placed in those low aspect ratio wings through which hot gas or fuel mixture can be expelled. The holes are positioned to allow the mixing of the hot gas with the incoming flow going into the gaps.

This configuration is also used for electrical propulsion, allowing a new architecture for distributed propulsion by placing electrical engines behind the low aspect ratio wings.

### STATE OF PRIOR ART

U.S. Pat. No. 10,986,451 describes a wingtip device that is moveable and can rotate between two positions. U.S. Ser. No. 08/595,588 describes a wing grid as a wing end section with the goal to increase aerodynamic efficiency.

U.S. Ser. No. 09/591,880 describes a wingtip having backswept lifting wings that can be individually controlled with the goal to reduce drag.

U.S. Ser. No. 08/011,770 describes a blended winglet which is a wing-like device attached to each wingtip.

The purpose of all the prior art mentioned above is to increase the aspect ratio of the main wing and harness a certain part of the energy from the wingtip vortices. A small amount of the energy from those vortices is recovered and the strength of the vortices is still big under certain conditions.

The new wing or blade design for wingtip device, rotor, propeller, turbine, and compressor blades with energy regeneration is a series of low aspect ratio wings placed in parallel with gaps between them connected by smaller wings that are placed in the gaps to harness the energy and produce forces; the gaps are shaped to decelerate the fluid and/or accelerate the fluid by varying the cross-sectional area.

Even if the small aspect ratio makes those wings inefficient, the strength of the vortices is smaller in the gaps.

Examination of state of the art especially in the field of patents has not made it possible to identify lift generation surfaces making it possible to solve the above problems contrary to the object of the present invention:

New wing or blade design for wingtip device, rotor, propeller, turbine, and compressor blades with energy regeneration.

### BRIEF SUMMARY OF THE INVENTION

The present invention concerns the new wing or blade design for wingtip device, rotor, propeller, turbine, and compressor blades with energy regeneration technically characterized by a series of low aspect ratio wings placed in parallel with gaps between them connected by smaller wings that are placed in the gaps to harness the energy and produce forces; the gaps are shaped to decelerate the fluid and/or accelerate the fluid by varying the cross-sectional area, and when they enter into synergy, make it possible to reduce the wingtip vortices, increase the overall lift and decrease the overall drag, propel vehicles more efficiently, compress fluids more efficiently, harness energy more efficiently. This system can be used as a wing, as a wingtip device, as a propeller for aircraft or boats or any vehicle moving through a fluid, in a compressor, as a rotor for wind turbine or helicopter, in a gas turbine.

### BRIEF DESCRIPTION OF THE SEVERAL VIEWS OF THE DRAWING

FIG. 1 is a perspective view of a low aspect ratio wing of the new wing or blade design for wingtip device, rotor, propeller, turbine, and compressor blades with energy regeneration.

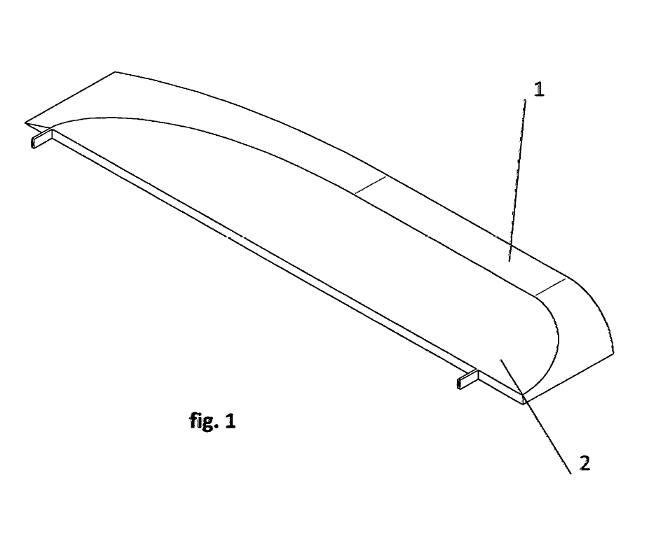

FIG. 2 is a perspective view of a low aspect ratio wing of the new wing or blade design for wingtip device, rotor, propeller, turbine, and compressor blades with energy regeneration.

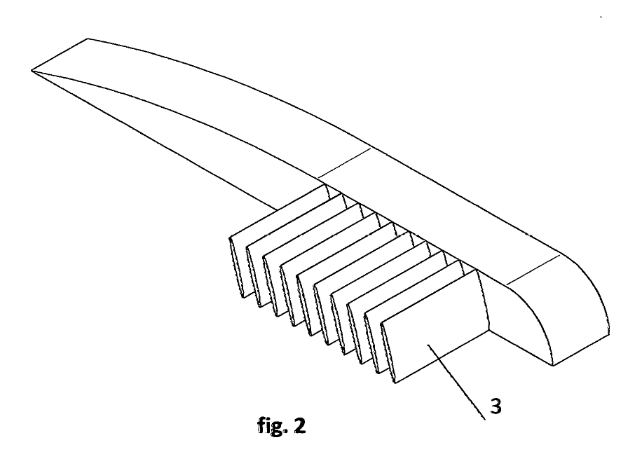

FIG. 3 is a perspective view of a serie of low aspect ratio wings of the new wing or blade design for wingtip device, rotor, propeller, turbine, and compressor blades with energy regeneration.

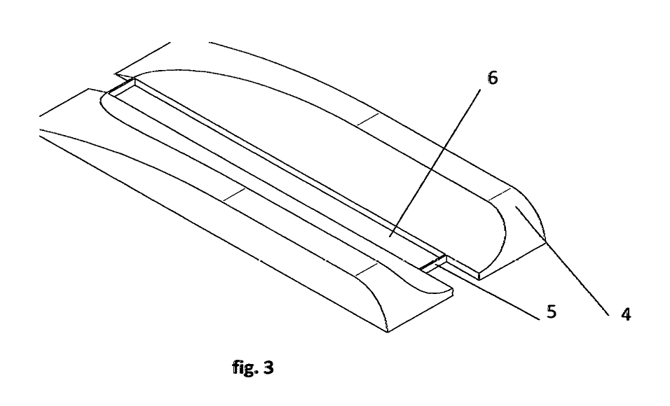

FIG. 4 is a perspective view of a low aspect ratio wing of the new wing or blade design for wingtip device, rotor, propeller, turbine, and compressor blades with energy regeneration.

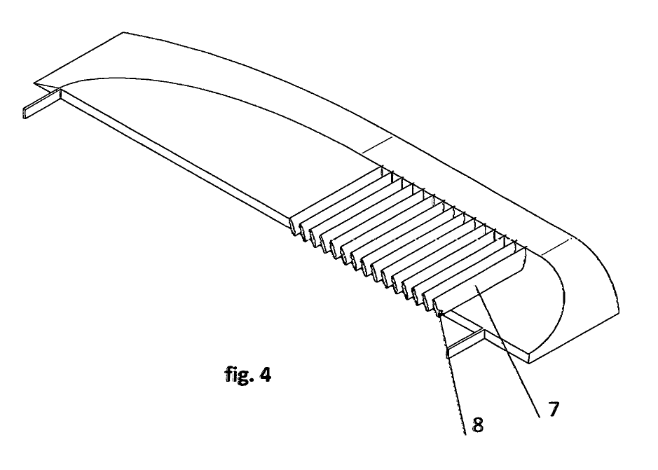

FIG. 5 is a perspective view of a low aspect ratio wing of the new wing or blade design for wingtip device, rotor, propeller, turbine, and compressor blades with energy regeneration.

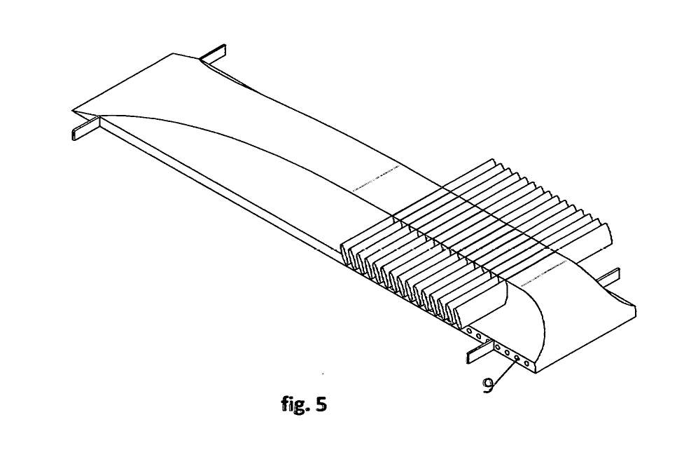

FIG. 6 is a top view of a low aspect ratio wing of the new wing or blade design for wingtip device, rotor, propeller, turbine, and compressor blades with energy regeneration.

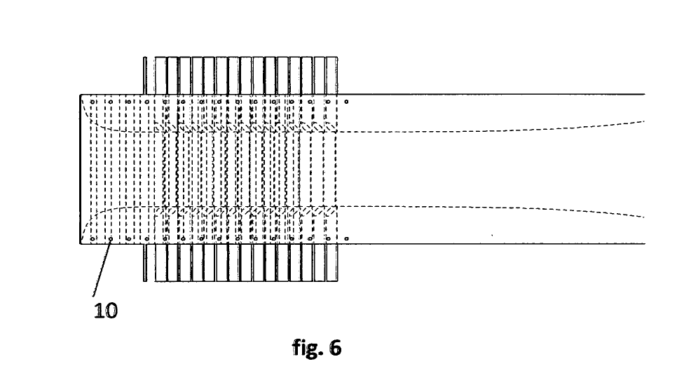

FIG. 7 is a perspective view of a series of low aspect ratio wings of the new wing or blade design for wingtip device, rotor, propeller, turbine, and compressor blades with energy regeneration.

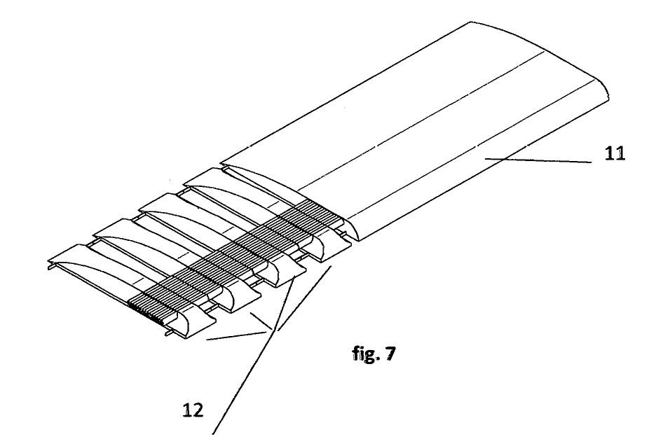

FIG. 8 is a perspective view of a series of low aspect ratio wings of the new wing or blade design for wingtip device, rotor, propeller, turbine, and compressor blades with energy regeneration.

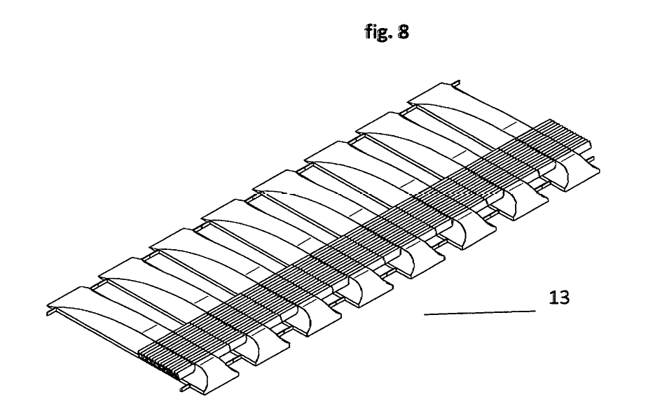

FIG. 9 is a perspective view of a turbine configuration of the new wing or blade design for wingtip device, rotor, propeller, turbine, and compressor blades with energy regeneration.

FIG. 10 is a perspective view of a compressor blisk of the new wing or blade design for wingtip device, rotor, propeller, turbine, and compressor blades with energy regeneration.

FIG. 11 is a perspective view of a series of low aspect ratio wings of the new wing or blade design for wingtip device, rotor, propeller, turbine, and compressor blades with energy regeneration.

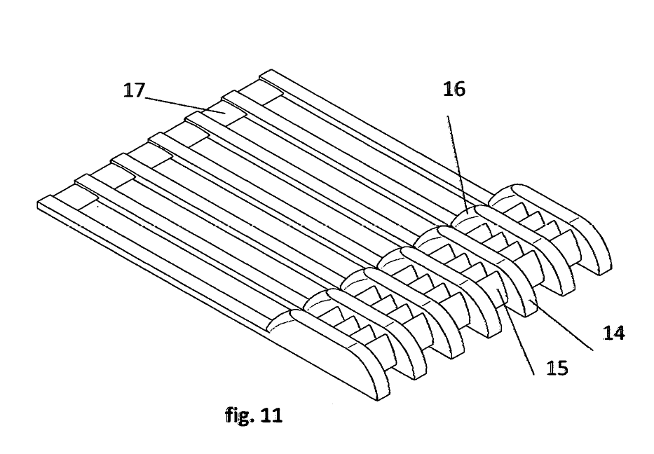

FIG. 12 is a perspective view of a series of low aspect ratio wings of the new wing or blade design for wingtip device, rotor, propeller, turbine, and compressor blades with energy regeneration.

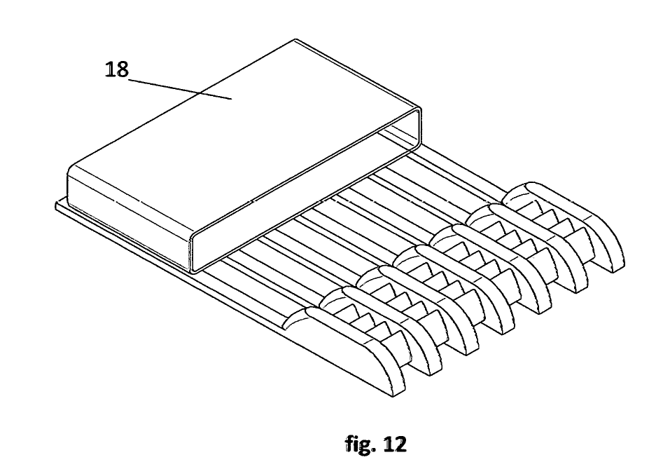

FIG. 13 is a perspective view of a series of low aspect ratio wings of the new wing or blade design for wingtip device, rotor, propeller, turbine, and compressor blades with energy regeneration.

### DETAILED DESCRIPTION OF THE INVENTION

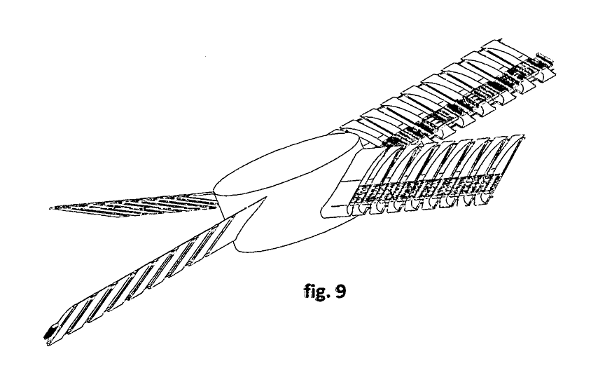

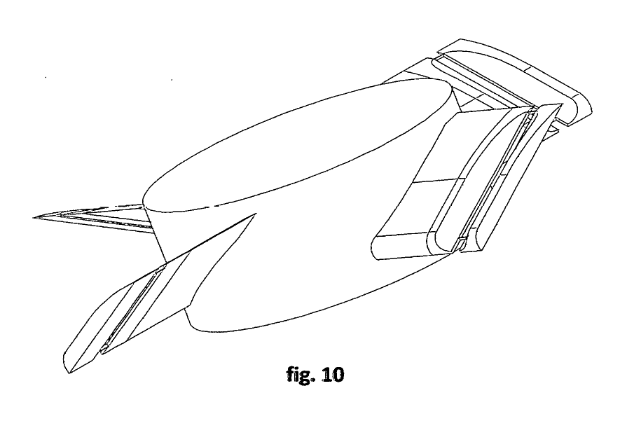

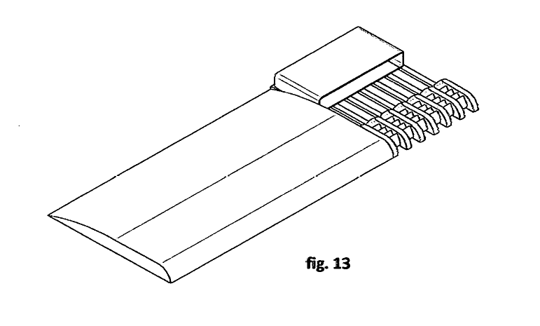

As shown in the drawings: The 1 corresponds to the low aspect ratio wing. The 2 corresponds to the gap that is shaped to decelerate the fluid and/or accelerate the fluid by varying the cross-sectional area. The 3 corresponds to the smaller wings that are placed in the gaps to harness the energy and produce forces. The 4 corresponds to the low aspect ratio wing. The 5 corresponds to a strut that connects adjacent low aspect ratio wings and takes the bending loads. The 6 corresponds to the gap that is shaped to decelerate the fluid and/or accelerate the fluid by varying the cross-sectional area. The 7 corresponds to the smaller wings that are placed in the gaps to harness the energy and produce forces. The 8 corresponds to a vortex generator to make the flow in the gap turbulent to keep the boundary layer attached. The 9 and 10 correspond to the small holes placed in those low aspect ratio wings through which hot gas or fuel mixture can be expelled. The holes are positioned to allow the mixing of the hot gas with the incoming flow going into the gaps. The 11 corresponds to the wing without the gaps. That wing could be used to store fuel. The 12 corresponds to the low aspect ratio wings with the gaps used to reduce the wingtip vortices and make the entire system more efficient. The 13 corresponds to a wing configuration made only of the low aspect ratio wings with the gaps. FIG. 9 is a perspective view of a turbine configuration of the new wing or blade design for wingtip device, rotor, propeller, turbine, and compressor blades with energy regeneration. FIG. 10 is a perspective view of a compressor blisk of the new wing or blade design for wingtip device, rotor, propeller, turbine, and compressor blades with energy regeneration. The 14 corresponds to the low aspect ratio wing. The 15 corresponds to the smaller wings that are placed in the gaps to harness the energy and produce forces. The 16 corresponds to the low aspect ratio wings but the remaining part of the airfoil has been removed for weight saving and skin drag reduction. The 17 corresponds to a strut taking the bending loads on another axis. The 18 corresponds to the compartment where propellers for distributed propulsion are placed to produce thrust. FIG. 13 shows the design of wing based on the new wing or blade design for wingtip device, rotor, propeller, turbine, and compressor blades with energy regeneration.

The new wing or blade design for wingtip device, rotor, propeller, turbine, and compressor blades with energy regeneration is a series of low aspect ratio wings placed in parallel with gaps between them connected by smaller wings that are placed in the gaps to harness the energy and produce forces; the gaps are shaped to decelerate the fluid and/or accelerate the fluid by varying the cross-sectional area. Even if the small aspect ratio makes those wings inefficient, the strength of the vortices is smaller in the gaps.

The aspect ratio of a wing is defined as the span length divided by the wing area to the square. A golden rule in aerodynamics is to have the highest aspect ratio for maximum efficiency. By increasing the span and keeping the same area, the wingtip vortices are reduced. Wingtip vortices are a major source of drag, particularly at low speed and high wing loading.

This invention called New wing or blade design for wingtip device, rotor, propeller, turbine, and compressor blades with energy regeneration goes against that golden rule previously described. By using a series of low aspect ratio wings placed in parallel with gaps between them, the motion of the fluid around the tips due to the pressure gradient is used to increase the overall efficiency of the entire system. Smaller wings are placed in the gaps to harness the energy and produce forces. The gaps are shaped to decelerate the fluid and/or accelerate the fluid by varying the cross-sectional area. Like diverging or converging nozzles, those gaps help to vary the pressure or transform the residual energy or thermal energy into kinetic energy. The gaps are placed in a way that they mainly go from the point of highest pressure at the bottom of the airfoil (intrados) to the point of lowest pressure at the top of the airfoil (extrados).

Also, there are small holes placed in those low aspect ratio wings through which hot gas or fuel mixture can be expelled. The holes are positioned to allow the mixing of the hot gas with the incoming flow going into the gaps.

This configuration is also used for electrical propulsion, allowing a new architecture for distributed propulsion by placing electrical engines behind the low aspect ratio wings.

1. New wing or blade design for wingtip device, rotor, propeller, turbine, and compressor blades with energy regeneration characterized by a series of low aspect ratio wings placed in parallel with gaps between them and connected via struts; the gaps are shaped to decelerate the fluid and/or accelerate the fluid by varying the cross-sectional area of the gaps.

2. New wing or blade design for wingtip device, rotor, propeller, turbine, and compressor blades with energy regeneration according to claim 1, characterized by smaller wings are placed in the gaps to harness the energy and produce forces.

3. New wing or blade design for wingtip device, rotor, propeller, turbine, and compressor blades with energy regeneration according to claim 1, characterized by the cross-sectional area of the gaps is variable by using actuators and pneumatic boots.

4. New wing or blade design for wingtip device, rotor, propeller, turbine, and compressor blades with energy regeneration according to claim 2, characterized by that the smaller wings in the gaps are mounted on hinges and connected to actuators imbedded in the low aspect ratio wings changing their angle of attack and that the smaller wings in the gaps can be folded in the gaps.

5. New wing or blade design for wingtip device, rotor, propeller, turbine, and compressor blades with energy regeneration according to claim 2, characterized by that the smaller wings in the gaps are folded into the low aspect ratio wings via a telescopic mechanism, thus varying the overall length.

6. New wing or blade design for wingtip device, rotor, propeller, turbine, and compressor blades with energy regeneration according to claim 2, characterized by that the smaller wings in the gaps are morphable wings and the profile of their airfoil can be changed for better aerodynamic shape by using actuators.

7. New wing or blade design for wingtip device, rotor, propeller, turbine, and compressor blades with energy regeneration according to claim 2, characterized by the design can be used as a propeller for aircraft or boat or any vehicle moving through a fluid.

8. New wing or blade design for wingtip device, rotor, propeller, turbine, and compressor blades with energy regeneration according to claim 1, characterized by the airfoils used for the low aspect ratio wings and smaller wings placed in the gaps can be supercritical airfoils, diamond shape airfoil for supersonic flow, any airfoil.

9. New wing or blade design for wingtip device, rotor, propeller, turbine, and compressor blades with energy regeneration according to claim 1, characterized by the design can be used as diffusers and static vanes in axial compressors or radial compressors.

10. New wing or blade design for wingtip device, rotor, propeller, turbine, and compressor blades with energy regeneration according to claim 1, characterized by the design can be used as rotors in axial or centrifugal compressors.

11. New wing or blade design for wingtip device, rotor, propeller, turbine, and compressor blades with energy regeneration according to claim 2, characterized by the design can be used as rotors for helicopters or wind turbines.

12. New wing or blade design for wingtip device, rotor, propeller, turbine, and compressor blades with energy regeneration according to claim 2, characterized by small holes placed in those low aspect ratio wings through which hot gas or fuel mixture can be expelled, the holes are positioned to allow the mixing of the hot gas with the incoming flow going into the gaps.

13. New wing or blade design for wingtip device, rotor, propeller, turbine, and compressor blades with energy regeneration according to claim 2, characterized by an array of propellers is placed behind the wings for distributed propulsion.
